(19) United States
(12) Patent Application Publication
(10) Pub. No.: US 2007/0000961 A1
(43) Pub. Date: Jan. 4, 2007

(54) Water bottle carrier for bicycles

(75) Inventor: Chang Ching Chung, Changhua Hsien (TW)

Correspondence Address: CHARLES E. BAXLEY, ESQ., 90 JOHN STREET, THIRD FLOOR, NEW YORK, NY, 10038, US

(73) Assignee: Ibera Co., Ltd.

(21) Appl. No.: 11/171,550

(22) Filed: Jun. 30, 2005

(51) Int. Cl. B62J 11/00; B62J 7/00; B62J 9/00

(52) U.S. Cl. 224/425; 224/450; 224/451

(57) ABSTRACT

A water bottle carrier for bicycles is fixed onto a frame of a bicycle by an axial base, and the axial base axially contains a handle of the water bottle. A transversal second connecting section is disposed at the bottom of the handle, and a first, a second and a third hole passages are interconnected to the axial wall of the axial base. The handle is turned clockwise to drive the second connecting section to turn from the first hole passage into the third hole passage through the second hole passage and fix the water bottle into the axial base. On the other hand, the handle is turned counterclockwise to turn the second connecting section form the third hole passage to the first hole passage to take out the water bottle.

### BACKGROUND OF THE INVENTION

1. Field of the Invention

The present invention relates to a water bottle carrier assembly installed at a frame of a cycle, and more particularly to an assembly for stably carrying a water bottle and providing a convenient angle for accessing the water bottle.

2. Description of the Related Art

Referring to FIG. 8, a prior art water bottle rack 10 for bicycles is an L-shape rack having a long arm 11 and a short arm 12, and a space disposed between the long and short arms 11, 12 for containing a water bottle 13. The long arm 11 includes a through hole for passing a screw to lock the long arm 11 to a frame tube 15, and the frame tube 15 generally refers to the down tube or seat tube of the bicycle.

In view of the shortcomings of the prior art water bottle rack, the water bottle 13 is always blocked by a top tube 16 when a bicycle rider moves the water bottle 13 in the direction parallel to the down tube 15. Therefore, the rider has to avoid the top tube 16 to get the water bottle 13. Furthermore, the water bottle rack 10 according to the foregoing arrangement applies an elastic clamping force onto the water bottle 13, and thus the rider has to use a relatively large force to take out the water bottle, which is very inconvenient and dangerous to the rider while riding a bicycle.

### SUMMARY OF THE INVENTION

The primary objective of the present invention is to provide a feasible solution, and the carrier can achieve the purposes of stably carrying the water bottle and facilitating the access of the water bottle. The water bottle carrier for bicycle in accordance with the present invention comprises:

An axial base, fixed to a frame of a bicycle and having an accommodating space at its axial direction and an opening at the top of the accommodating space;

A first hole passage, longitudinally extended downward from the top of the axial base to an appropriate hole length;

A third hole passage, having a hole length shorter than that of the first hole passage, and the first hole passage is parallel to an axial wall of the axial base proximate to the end of the first hole passage;

A second hole passage, disposed at the axial wall of the foregoing axial base and interconnected with the first and second hole passages, and the second hole passage is shorter than the hole length of the third hole passage and form a boundary with the third hole passage;

A resilient member, disposed at the bottom of the accommodating space; and

A handle, fixed to the water bottle and having a handle body and a second connecting section connected to the handle body, and the handle body is passed into the accommodating space, and the second connecting section is extended into the first hole passage of the axial base, and the second connecting section is turned into the second hole passage and fixed into the third hole passage.

The present invention achieves one of the objectives and performance by turning the handle body of the handle of the water bottle in the axial base, such that the second connecting section of the handle can be moved inside the first, second, and third hole passages on the wall of the axial base. If the second connecting section is moved into the third hole passage, the water bottle is restricted in the axial base. If the second connecting section is moved to the first hole passage, the water bottle can be accessed.

The present invention achieves another objective and performance by using the resilient member in the axial base to latch the second connecting section of the handle into the third hole passage and secure the water bottle. The resilient member provides an appropriate distance for users to take out the water bottle with its handle together more easily, when a user accesses the water bottle.

### BRIEF DESCRIPTION OF THE DRAWINGS

FIG. 1 is an exploded view of an axial base, a handle and a water bottle of the present invention;

FIG. 2 is a perspective view of an axial base, a handle and a water bottle being assembled according to the present invention;

FIG. 3 is another perspective view of an axial base, a handle and a water bottle being assembled according to the present invention;

FIG. 4 is a cross-sectional view of Section 4-4 as depicted in FIG. 2;

FIG. 5 is a cross-sectional view of Section 5-5 as depicted in FIG. 3;

FIG. 6 is a planar view of an axial base being installed at a frame of a bicycle and a water bottle being installed into the axial base according to the present invention;

FIG. 7 is a planar view of an axial base being installed at a frame of a bicycle and a water bottle being accessed according to the present invention; and

FIG. 8 is a planar view of a prior art water bottle rack for bicycles and the prior art water bottle being installed at a frame of the bicycle.

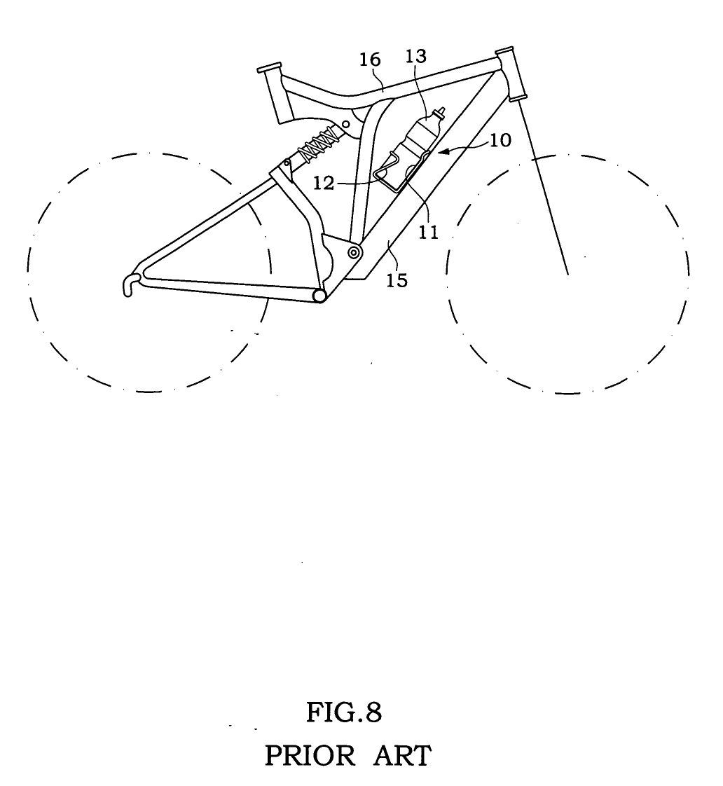

### DETAILED DESCRIPTION OF THE PREFERRED EMBODIMENTS

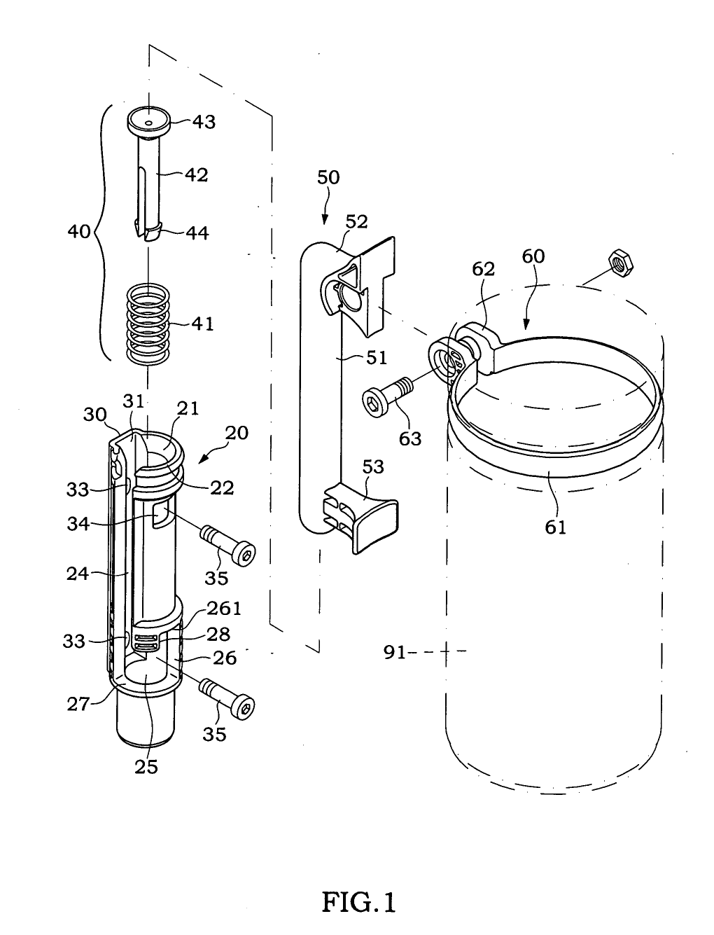

Referring to FIG. 1, a water bottle carrier of the invention includes an axial base 20, a handle 50, and a water bottle clamp ring 60.

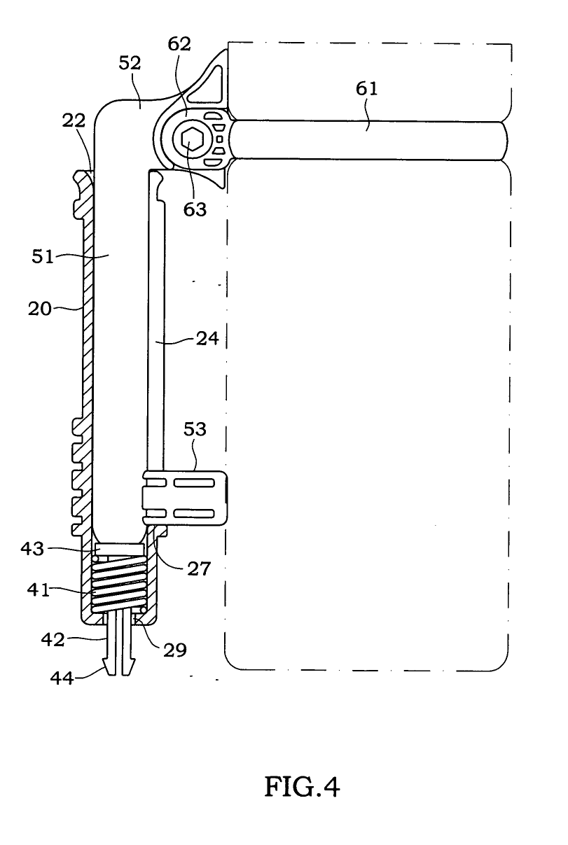

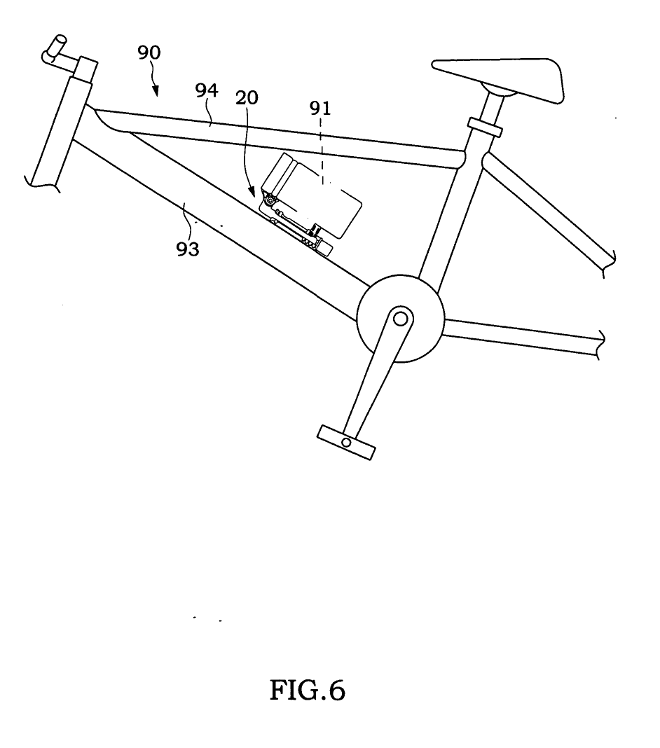

The axial base 20, having an accommodating space 21 with a circular cross-section along its axial direction, an opening 22 disposed at the top of the accommodating space 21, a latch hole 20 disposed at the bottom of the accommodating space 21 as shown in FIG. 4. The axial wall of the axial base 21 has a first hole passage 24 and a third hole passage 26, and the first hole passage 24 extends an appropriate hole length longitudinally downward from the top of the axial base 20, and the third hole 26 passage is parallel to the first hole passage 24 and has a length shorter than the first hole passage 24, and is disposed on the wall proximate to the first hole passage 24. A second hole passage 25 is disposed on the wall between the first hole passage 24 and the third hole passage 26 to interconnect the first hole passage 24 and the third hole passage 26, but the hole length of the second hole passage is shorter than the hole length of the third hole passage 26, and the first, second, and third hole passages 24, 25, 26 form a continuous turning-free hole flange 27 at the axial wall of the axial base 20 at a lower end. Therefore, a boundary 28 is formed at the intersection of the second and third hole passages 25, 26. The axial base 20 further includes a fixing section 30 at other axial walls, and the fixing section 30 corresponding to the internal surface of the axial base 20 is interconnected with the accommodating space 21 through a groove 31, and the external surface is a flat surface, and the fixing section 30 further includes at least two fixing holes 33 disposed at an upper and a lower rows. An opening 34 is disposed on an axial wall corresponding to a horizontal surface of the axial base 20 and the fixing hole 33, such that a hand tool is used to pass a fixing member 35 into the fixing hole 33 through the opening 34, and the axial base 20 is fixed onto the external surface of a frame 90 as shown in FIG. 6.

A resilient member 40 is installed at the bottom of the foregoing accommodating space 20, and the resilient member 40 is comprised of a spring 41 and an axle 42 pivotally sheathed into the spring 41, and a blocking member disposed at the top of the axle 42 to stop an end of the spring 41, a latching section 44 disposed at the bottom of the axle 42 and capable to be elastically extended or contracted. The latching section 44 is latched to a hole bottom of the latch hole 29 of the axial base 20 when the spring is extended.

The handle 50 includes a handle body 51, and a first connecting section 52 and a second connecting section 53 integrally connected to both ends of the handle body 51.

The water bottle clamp ring 60 includes an open ring section 61 and a connecting section 62 connected at both open ends of the ring section 61, and the ring section 61 is bound around the body of the water body 91, and the connecting section 62 is connected to the first connecting section 52 of the handle 51 and fixed by a connecting member 63. The open end of the second connecting section 53 of the handle 50 is pressed on the external surface of the water bottle 91.

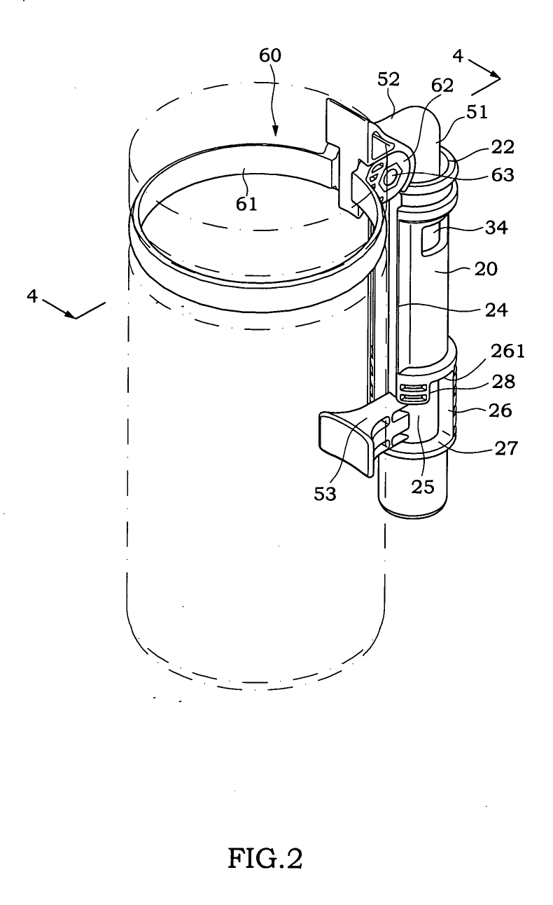

Referring to FIGS. 2 and 4, a user turns the handle body 51 of the handle 50 of the water bottle 91 axially with respect to the opening 22 of the axial base 20, and the second connecting section 52 with respect to the first hole passage 24 of the axial base 20, such that the handle body 51 is passed into the accommodating space 21. A slight force is applied to the bottom of the handle body 51 to compress the resilient member 40 until the bottom surface of the second connecting section 53 is in contact with the hole flange 27. Now, the handle 50 is turned to an appropriate angle such that the second connecting section 53 passes through the second hole passage 25 into the third hole passage 26.

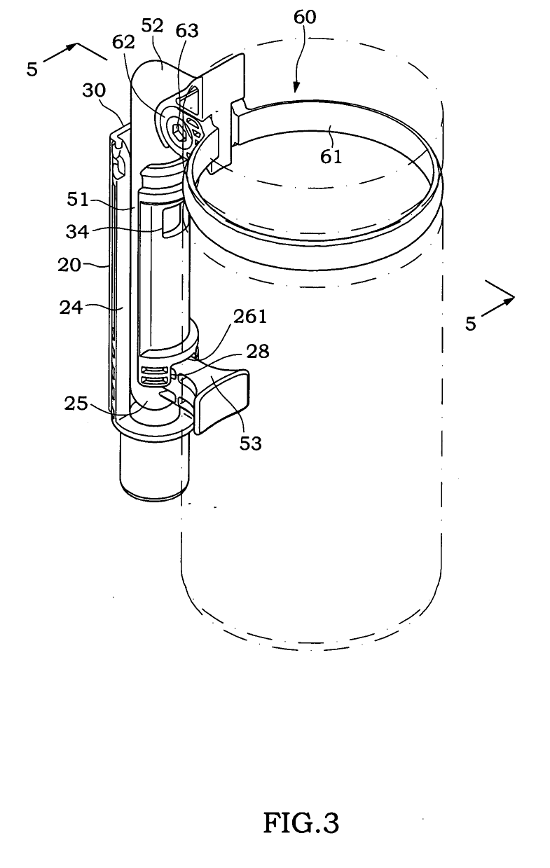

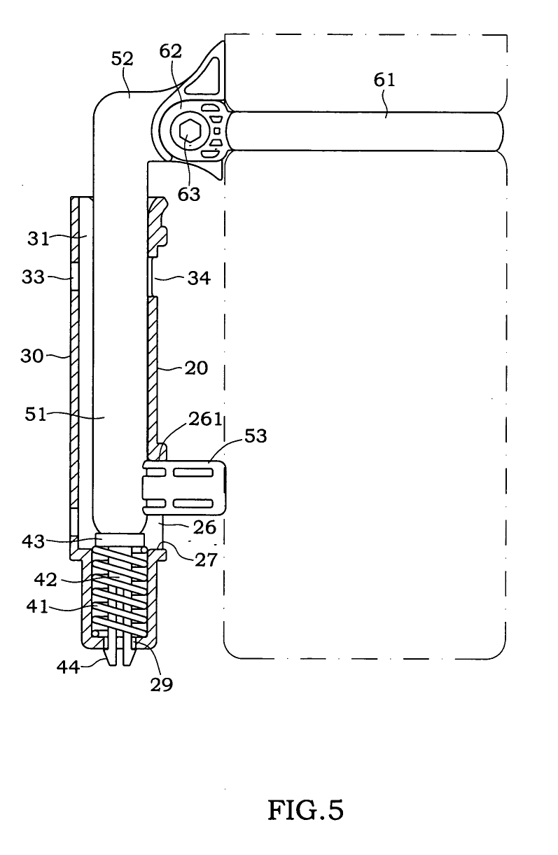

Refer to FIGS. 3 and 5. After the second connecting section 53 of the handle 50 enters into the third hole passage 26, the compression of the resilient member 40 is released, and the resilient member 40 pushes the second connecting section 53 to move the handle 50 and the water bottle 91 upward. The second connecting section 53 presses on an upper hole wall 261 of the third hole passage 26. Now, the second connecting section 53 is blocked by the boundary 28 and cannot be returned to the first hole passage 24. Thus, the water bottle 91 is fixed to the axial base 20 by the handle 50.

If it is necessary to take out the water bottle, then the above-mentioned procedure is reversed. It is worth to point out that when the second connecting section 53 is passed from the second hole passage 25 into the first hole passage 24, the resilient member 40 is released to push the handle 50 as well as the water bottle upward, so that a user can take out the water bottle easily without using much force.

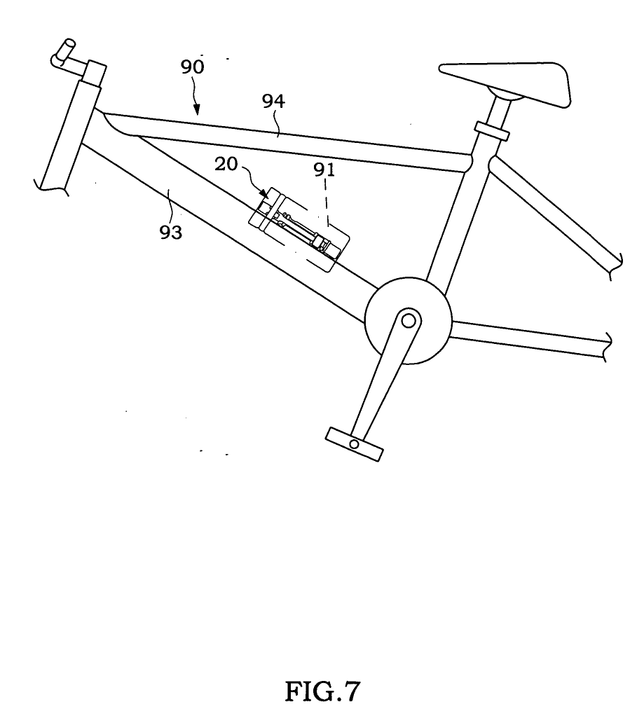

Refer to FIGS. 6 and 7 for the axial base 20 fixed on the down tube 93 of the frame 90. When the water bottle 91 is fixed to the axial base 20, the water bottle 91 is located exactly under the top tube of the frame 90, since the third hole passage 26 and the fixing section 30 are linearly disposed with respect to the wall of the axial base 20. When the water bottle 91 is accessed, the second connecting section 53 of the handle 50 is turned into the first hole passage 24, and the water bottle 91 is turned to leave the blocking area of the top tube 94. This position allows riders to access the water bottle 91 at a direction parallel to the down tube 93 without being blocked by the top tube 94.

In summation of the above description, the present invention herein enhances the performance and overcomes the shortcoming of the prior art, and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A water bottle carrier for bicycles, comprising:
an axial base, fixed to a frame of a bicycle, and having an accommodating space disposed along its axial direction and an opening disposed at the top of said accommodating space;
a first hole passage, extended to an appropriate hole length from the top of said axial base longitudinally downward;
a third hole passage, having a hole length shorter than said first hole passage, and said first hole passage being disposed in parallel to an axial wall of said axial base proximate to an end of said first hole passage;
a second hole passage, disposed on an axial wall of said axial base and interconnected with said first and second hole passages, and the hole length of said second hole being shorter than that of said third hole passage, and said second hole passage forming a boundary with said third hole passage;
a resilient member, disposed at the bottom of said accommodating space; and
a handle, fixed to said water bottle and including a handle body and a second connecting section transversally coupled to said handle body, and said handle body being passed into said accommodating space, and said second connecting section being entered into said first hole passage of said axial base to axially turn said handle, and said second connecting section can be turned into said second hole passage and further fixed into said third hole passage.

2. The water bottle carrier for bicycles of claim 1, wherein said first, second, and third hole passages form a continuous turning-free hole flange disposed at the bottom of said axial wall of said axial base.

3. The water bottle carrier for bicycles of claim 1, wherein said axial wall of said axial base includes a fixing section having at least one fixing hole for securing said fixing member, so as to fix said axial base onto said frame.

4. The water bottle carrier for bicycles of claim 3, wherein the internal surface of said fixing section with respect to said axial base is interconnected with said accommodating space by a groove, and an opening is disposed on said axial base at said axial wall corresponding to a horizontal straight line of said fixing hole, for passing said fixing member into said fixing hole through said opening and fixing said fixing member onto said frame.

5. The water bottle carrier for bicycles of claim 3, wherein said fixing section has a planar external surface.

6. The water bottle carrier for bicycles of claim 3, wherein said third hole passage and said fixing section are disposed linearly on said axial wall of said axial base.

7. The water bottle carrier for bicycles of claim 1, wherein said resilient member includes a spring and an axle pivotally sheathed into said spring, and said axle includes a blocking member disposed at the top of said axle for blocking the top of said spring, and a latching section disposed at the bottom of said axle and capable of being extended or contracted.

8. The water bottle carrier for bicycles of claim 7, wherein said axial base includes a latch hole disposed at the bottom of said axial base, and said axle is passed into said latch hole, such that when said spring is extended, said latching section at the bottom of said axle is latched to a hole bottom of said latch hole.

9. The water bottle carrier for bicycles of claim 1, wherein said handle further comprises a first connecting section for connecting said water bottle.

10. The water bottle carrier for bicycles of claim 9, wherein said water bottle includes a water bottle clamp ring, and an open end of said water bottle clamp ring is coupled with said first connecting section of said handle.

11. The water bottle carrier for bicycles of claim 9, wherein said water bottle clamp ring further comprises an open ring section and a connecting section disposed at both open ends of said ring section, and said ring section is bound around a body of said water bottle, and said connecting section is coupled with said first connecting section of said handle and fixed by a fixing member.

12. The water bottle carrier for bicycles of claim 1, wherein said second connecting section of said handle has an open end pressing on the external surface of said water bottle.
